(19) United States
(12) Patent Application Publication
(10) Pub. No.: US 2004/0178254 A1
(43) Pub. Date: Sep. 16, 2004

(54) Easy open folding carton and method for manufacturing same

(76) Inventors: Michael P. Ronan, Grand Rapids, MI (US); Thomas C. Plett III, Ionia, MI (US); Craig A. Hower, Ada, MI (US); Bruce Valkier, Belding, MI (US); Mark F. Mettler, Spring Lake, MI (US)

Correspondence Address: LYNN SCHWENNING, Alticor Inc., 7575 Fulton Street East 78-2G, Ada, MI, 49355, US

(21) Appl. No.: 10/659,077

(22) Filed: Sep. 10, 2003

Related U.S. Application Data
(63) Continuation-in-part of application No. 10/389,239, filed on Mar. 14, 2003, now abandoned.

(51) Int. Cl. B26D 5/42

(52) U.S. Cl. 229/153; 229/198.2

(57) ABSTRACT

An easy-open folding carton having a manufacturer's joint in which two panels are joined by an adhesive. One of the two panels includes a plurality of punch scores. The other panel is coated with a coating and includes a plurality of uncoated “knock-outs” that are aligned with the punch scores. The adhesive is disposed between the two panels in alignment with the knock-outs and punch scores. The panel that includes the punch scores is preferably coated, except for an uncoated stripe that extends through the approximate center of the punch scores. The present invention also provides a method for manufacturing a carton including the steps of (a) forming a carton blank having an adhesive panel and a first panel, (b) forming punch scores in one of the adhesive panel and the first panel, (c) coating the other of the first panel and the adhesive panel leaving a pattern of uncoated knock outs positioned to align with the punch scores in the assembled carton, (d) folding the blank into a carton, and (e) securing the adhesive panel to the first panel by an adhesive disposed between the punch scores and knock outs.

### RELATED APPLICATIONS

This application is a continuation-in-part of U.S. patent application Ser. No. 10/ 389,239, filed Mar. 14, 2003.

### BACKGROUND OF INVENTION

The present invention relates to cartons and, more specifically, to paperboard folding cartons and methods for manufacturing the same.

Folding cartons are well known in the packaging art. Cartons are typically constructed from flat blanks that are pre-cut and pre-scored on sheets of paperboard. The carton blank will have a number of panels to form the sides of the carton. A blank for a rectangular carton, for example, will have four main panels, which form the four sides of the carton. A manufacturer's joint, or closing tab, attached to one end of the blank is generally used to secure the shape of the carton after it is folded. This tab is generally connected to one of the panels of the blank by an adhesive.

The adhesive in a typical carton forms a strong bond between the tab and the panel. This bond between the tab and the panel has a high shear strength, which means when the panel and tab are moved against each other laterally, such as in a rubbing motion, it is difficult to separate them. This keeps the carton from opening during shipping and storage. The adhesive bond also generally creates a high peel strength, which is the force required to pull the tab away from the panel in a generally perpendicular direction. A high peel strength makes it difficult to tear the carton open.

To conserve paper, and to reduce cost and labor, it has become desirable in the packaging industry to print product information on the inside of the product carton. This eliminates the need for a printed insert detailing the characteristics and uses of the product. To read the printed information, the carton must be opened; but, so far the methods devised to facilitate this have been less than satisfactory.

Tearing at the location of the adhesive can generally open the carton. The problem with this method, however, is that it is difficult to get a clean tear. Due to the high peel strength of a typical carton, the tab and first panel often will not separate completely when the user tears at the carton. Frequently the inside of the carton is torn, which makes it difficult to read the printed interior of the carton. Even if the carton is not torn, the separation of the tab from the first panel can cause delamination of the interior of the carton. This removes the inner surface layer of the paperboard, which is where the printed material is located. Again, this makes it very difficult to read the information on the inside of the carton.

Another method used to aid in opening the carton is to die-cut perforations into the paperboard along a pre-scored line. The user will then tear along the perforation to open the carton. While this eliminates the problems associated with high peel strength, the process introduces other deficiencies. First, aesthetically this method is lacking. After a perforation is made, cut and exposed fibers remain along the perforation. Second, it is difficult to vary the amount of force needed to open the carton with this method. A high degree of perforation, which would make opening the carton easier, would affect the integrity of the carton. Increasing the degree of perforation would also increase the chance of the carton opening during filling and/or shipping. As a result, the degree of perforation, and thus the ease of opening, is limited. Additionally, since the perforation is exposed when the carton is folded, there is an increased possibility of unintentional tears along the perforation.

It is therefore desirable in the art to have a carton designed to be easily opened with varying degrees of force. It is also desirable to have a carton with a low peel strength designed to eliminate delamination when opening the carton.

### SUMMARY OF THE INVENTION

The aforementioned problems are overcome by the present invention wherein a folding carton is provided with a manufacturer's joint having one panel with a plurality of punch scores and another panel that defines a plurality of knock-outs aligned with at least some of the punch scores. The two panels are joined to one another by an adhesive disposed between the punch scores and knock-outs.

In a first embodiment, the punch scores are disposed on the manufacturer's joint, or adhesive panel, of the carton. With the exception of the knock-outs, the first panel of the carton is coated on the surface facing the adhesive panel. The knock-outs are configured to align with the punch scores when the carton is assembled.

In another embodiment, the adhesive panel includes a coating over the surface having the punch scores. An uncoated stripe is defined over the surface through the center of the punch scores.

In yet another embodiment of the invention the panels are coated on both sides, with the exception of the uncoated stripe on the adhesive panel and the knock outs on the first panel. An outside coating is generally used to protect the carton from scuffs during shipping and storage. An inside coating protects from scuffing as the product contained in the carton rubs against the carton panels. In all of the embodiments described herein, various combinations of the punch scores, knock outs, uncoated stripe, and the coatings on the cartons can be made to adjust both the peel and shear strength of the carton to a predetermined value that is suitable to provide a carton that is both easy to open without tearing the inner coating but yet be strong enough to withstand premature opening of the carton during transport.

The present invention also provides a method for manufacturing a carton including the steps of (a) forming a carton blank having a manufacturer's joint and a first panel, (b) forming punch scores in one of the manufacturer's joint and the first panel, (c) coating the other of the first panel and the manufacturer's joint leaving a pattern of uncoated knock outs positioned to align with the punch scores in the assembled carton, (d) folding the blank into a carton, and (e) securing the manufacturer's joint to the first panel by an adhesive disposed between the punch scores and knock outs.

This invention provides a simple and inexpensive folding carton with a relatively low peel strength and a relatively high shear strength. The high shear strength resists unintended opening of the carton during shipping and storage. The low peel strength permits the carton to be easily opened by a consumer to obtain access to information printed on the interior. The punch scores also help to isolate any tearing of the panels that may occur when the carton is opened, thus preserving printed matter on the interior of the carton. Further, the peel strength and shear strength can be readily and independently varied by changing, among other things, the number, size and geometry of the uncoated knock outs, uncoated stripe, punch scores and the amount of adhesive used.

These and other objects, advantages, and features of the invention will be readily understood and appreciated by reference to the detailed description of the preferred embodiment and the drawings.

### BRIEF DESCRIPTION OF THE DRAWINGS

FIG. 1 is a left side perspective view of a folding carton manufactured in accordance with a preferred embodiment of the present invention;

FIG. 2 is a right side perspective view of the folding carton in a partially closed position;

FIG. 3 is a perspective view of a carton blank used in the manufacture of the carton;

FIG. 4 is a top plan view of a first embodiment of the carton blank;

FIG. 5 is a top plan view of a second embodiment of the carton blank;

FIG. 6 is a bottom plan view of the second embodiment of the carton blank;

FIG. 7 is a side elevational view of a portion of the carton showing the manufacturer's joint according to the first embodiment; FIG. 8 is a side elevational view of a portion of the carton showing the manufacturer's joint according to the second embodiment;

FIG. 9 is a schematic of an icon printed on the carton;

FIG. 10 is a top plan view of the carton showing a configuration of punch scores and slits for use in modifying the peel or shear strength of the carton.

FIG. 11 is a top plan view of the carton showing a shortened uncoated racing strip over the punch scores for use in modifying the peel or shear strength of the carton; and

FIG. 12 is a top plan view showing a modified knock out configuration for use in modifying the peel or shear strength of the carton.

### DETAILED DESCRIPTION OF THE PREFERRED EMBODIMENT

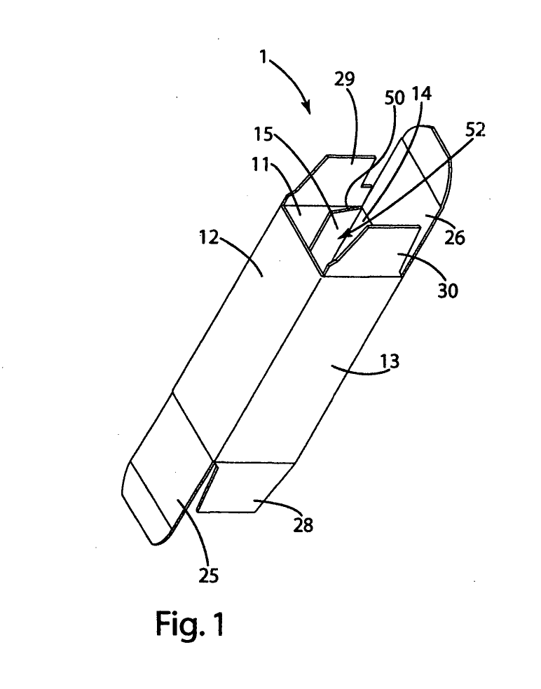

An easy open folding carton 1 in accordance with a preferred embodiment of the present invention is shown in FIG. 1. The carton 1 is a generally rectangular carton intended to contain a tube of cosmetics or other similar contents. The carton 1 generally includes a plurality of panels 11, 12, 13 and 14 that define the sidewalls of the carton 1 as well as dust flaps 27 (not shown), 28, 29 and 30 and closure flaps 25, 26 that define the top and bottom of the carton 1. Instructions, product data and other information are printed on the interior of the carton 1. The carton 1 includes a manufacturer's joint 50 that is readily opened after the contents of the carton 1 have been removed to provide access to the information printed on the interior of the carton 1. While the present invention will be described in relation to a rectangular carton intended to contain a tube of cosmetics or other similar contents, the present invention is well suited for use with cartons of essentially any shape and for holding essentially any contents.

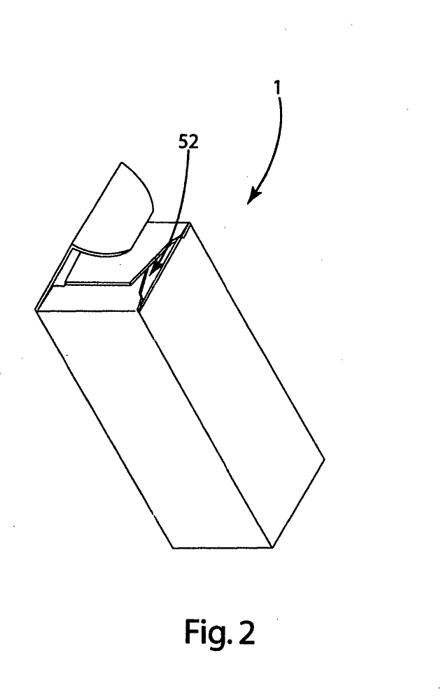

As noted above, the carton 1 is generally rectangular defining an internal space 52 for containing one or more products. The carton 1 generally includes a right panel 11, a front panel 12, a left panel 13 and a back panel 14 that define the sidewalls of the container. The carton 1 further includes a pair of dust flaps 29, 30 and a top closure flap 26 that close the top of the carton 1 and a pair of dust flaps 27, 28 and a bottom closure flap 25 that close the bottom of the carton 1. The dust flaps 27, 28, 29 and closure flaps 25, 26 are shown in a substantially open position, and are closed in a conventional manner. As can be seen from FIG. 2, the bottom of the carton 1 generally remains in the closed position, and the top of the carton 1 is opened to access the product housed in the carton 1. In addition, the top of the carton 1 is generally left open after fabrication until insertion of a product into the internal space 52 of the carton 1. Insertion of the product generally occurs on an assembly line.

The panels 11, 12, 13 and 14 are arranged in a rectangular shape and are retained in this shape by an adhesive panel 15 (also referred to as the manufacturer's joint) . The adhesive panel 15 extends from the back panel 14 and is adhesively secured to the interior surface of the right panel 11. The adhesive panel 15 includes a plurality of spaced-apart punch scores 8 (not shown). Further, the right panel 11 includes a plurality of spaced-apart knockouts 9 (not shown), which are preferably aligned with the punch scores 8.

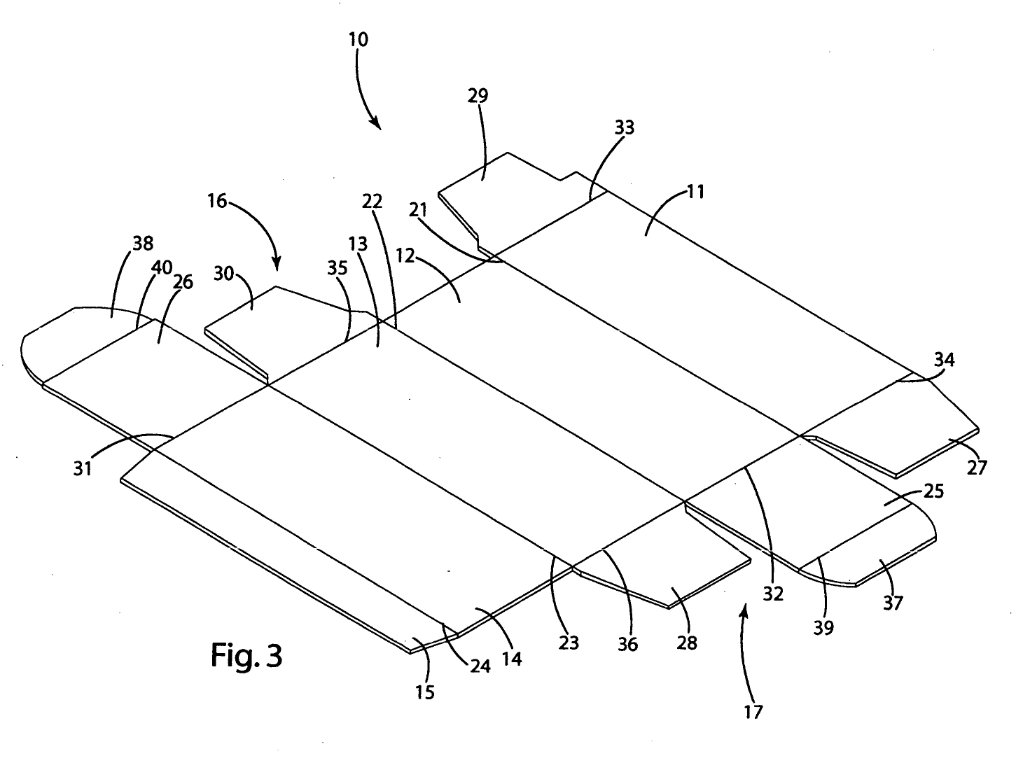

The carton 1 will now be described in greater detail with reference to FIGS. 3-8, which show the carton blank 10 used in the manufacture of the carton 1 of the preferred embodiment. FIG. 3 shows the front surface of a blank 10 for forming the carton 1. As shown the carton 1 is preferably manufactured from a one-piece, laminated paperboard blank 10 that is folded in a conventional manner to form the carton 1. In the preferred embodiment, the paperboard blank is manufactured from conventional paperboard materials having a thickness of approximately 0.010 to 0.024 inches. The specific paperboard will vary from application to application based primarily on the desired characteristics of the carton. In the preferred embodiment, the blank 10 has coated front and back surfaces. It is not necessary, however, for any portion of the front surface of the blank to be coated. The coating, when used, can be applied by any method known in the art for applying coatings to paperboard, such as by a printing press. The coating is preferably a UV varnish, though any of a wide variety of conventional paperboard coatings could be used. In a preferred embodiment, the front surface of the blank 10 is coated with a UV varnish and the rear surface is also coated with a UV varnish.

The basic structure of a carton blank is shown in FIG. 3. The blank 10 has a top end 16 and a bottom end 17. The blank 10 further has a right panel 11, a front panel 12, a left panel 13, a back panel 14, and an adhesive panel 15. The light panel 11 is connected to the front panel 12 along fold line 21. The front panel 12 is connected to the left panel 13 along fold line 22. The left panel 13 is connected to the back panel 14 along fold line 23. The back panel 14 is hingedly connected to the adhesive panel 15 along fold line 24. The size, shape and configuration of the various panels can vary from application to application as desired.

Further, there is a bottom closure flap 25 and a top closure flap 26 that, as noted above, close the top and bottom ends of the carton 1. The bottom closure flap 25 is connected to the bottom end 17 of the front panel 12 along fold line 32, and the top closure flap 26 is connected to the top end 16 of the back panel 14 along fold line 31. In addition, the bottom closure flap 25 includes a locking tab 37 defined by fold line 39. Similarly, the top closure flap 26 includes a locking tab 38 defined by fold line 40. The bottom closure flap 25 and top closure flap 26 could be alternatively connected to different panels.

There are also four dust flaps, 27, 28, 29 and 30 in the preferred embodiment. The dust flaps 27, 28, 29 and 30 are closed over the top and bottom ends of the carton 1 before the closure flaps 25 and 26 are closed. The top dust flaps 29 and 30 extend from the top end 16 of the right panel 11 and left panel 13, respectively. Top dust flap 29 is connected to the right panel 11 along fold line 33. Top dust flap 30 is connected to the left panel 13 along fold line 35. Similarly, the bottom dust flaps 27 and 28 extend from the bottom end 17 of right panel 11 and left panel 13, respectively. Bottom dust flap 27 is connected to right panel 11 along fold line 34 and bottom dust flap 28 is connected to left panel 12 along fold line 36.

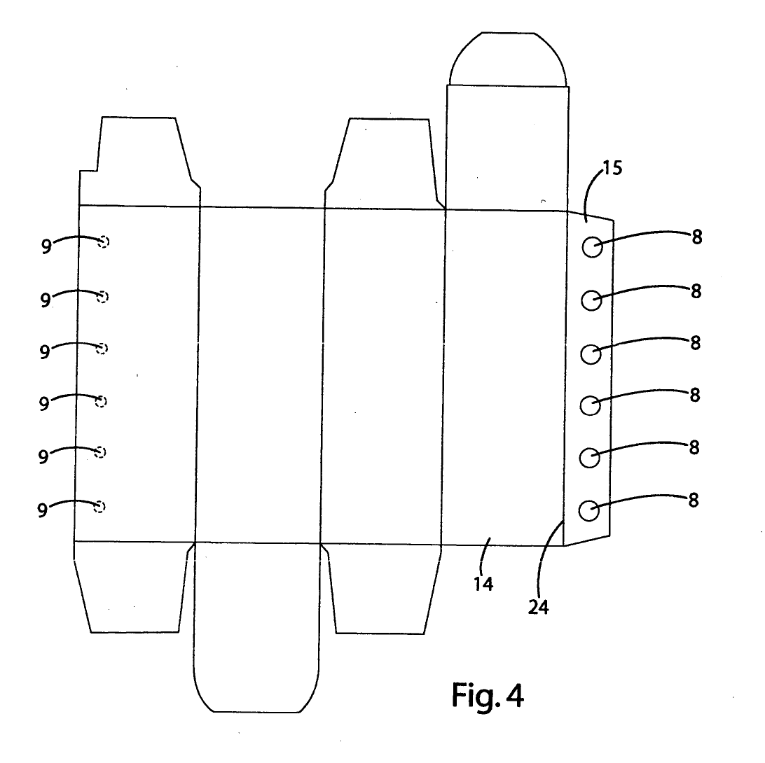

In the preferred embodiment shown in FIG. 4, the adhesive panel 15 extends from back panel 14 and is connected thereto by fold line 24. The adhesive panel 15 includes a number of spaced-apart punch scores 8. These punch scores 8 can be to almost any depth in the adhesive panel 15, but in the preferred embodiment the punch scores 8 penetrate approximately ½the depth of the adhesive panel 15. In the illustrated embodiment, the punch scores 8 are circular, but they can be of nearly any shape. The punch scores 8 can be created using any appropriate method in the art, such as penetrating the blank 10 with a punch. The size of the punch scores 8 will vary from application to application, keeping in mind that, with typical paperboard, adhesives and coatings, the punch scores make it easier to open the carton by facilitating separation between layers of the laminated paperboard. As a result, an increased number of punch scores or punch scores of a larger diameter will typically make it easier to open the carton. Variations in the size, shape, number and configurations of the punch scores will effect primarily the peel strength of the carton 1. Accordingly, the characteristics of the punch scores can be altered to affect the peel strength of the carton 1 largely independent of the shear strength.

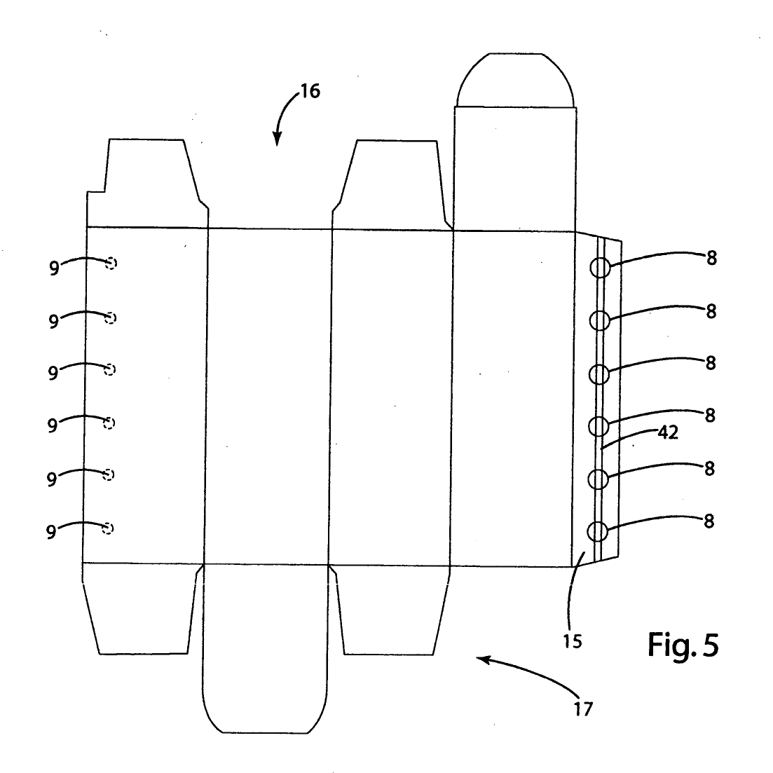

In addition, FIG. 5 shows an alternate embodiment of the adhesive panel 15 in which there is an uncoated stripe 42 on the adhesive panel 15. The uncoated stripe 42 can be any length, but in the preferred embodiment the uncoated stripe 42 runs from the top end 16 to the bottom end 17 of the adhesive panel 15 through the center of the punch scores 8. The uncoated stripe 42 can be created using any method known in the art, such as defining the stripe on the printing plate used for applying the coating. Because coatings decrease adhesion, the size (including both width and length) of the uncoated stripe 42 will affect the ease of opening of the carton. The larger the uncoated stripe 42 is the greater the adhesion will be, and the more difficult it will be to open the carton. This will increase both the peel strength and shear strength of the carton 1.

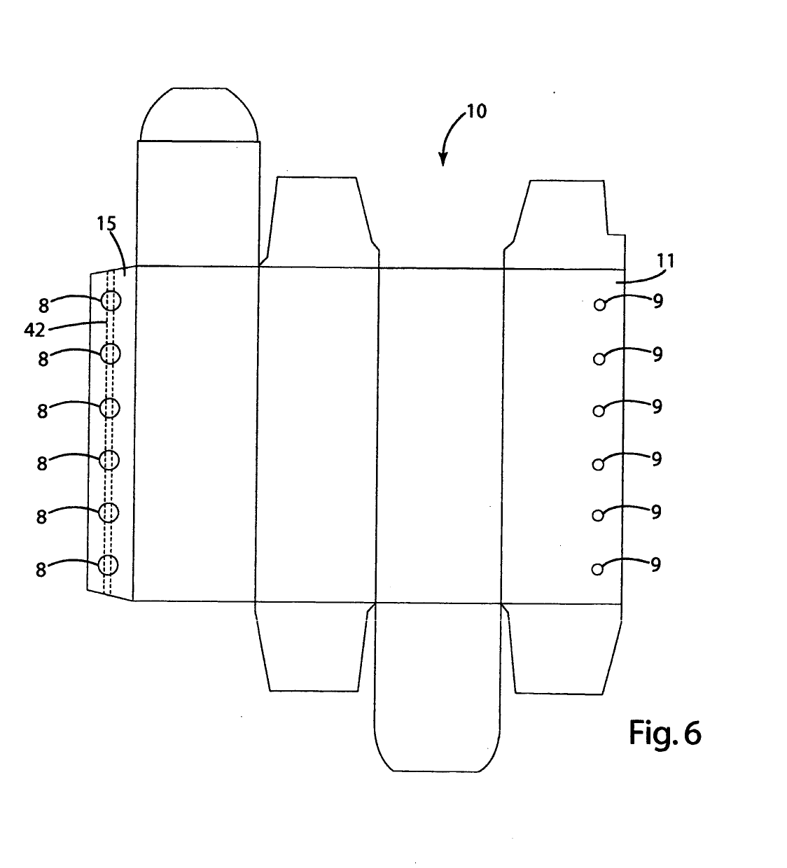

FIG. 6 shows the back surface of the blank 10. Differences between the back surface of the blank 10 and the front surface of the blank 10 in the preferred embodiment relate only to the adhesive panel 15 and the right panel 11. The punch scores 8 and uncoated stripe 42 are not present on the back surface of the adhesive panel 15. In the preferred embodiment, the back surface of the right panel 11 is coated and has a number of uncoated portions, or knock outs 9. These knock outs 9 can be created using any appropriate method in the art, such as defining the knock outs 9 in the printing plate used for applying the coating. The knock outs 9 can be any size and shape, but are preferably approximately the same size and shape as the punch scores 8. Since most coatings will decrease adhesion, the size of the knock outs 9 can affect both the peel and shear strength of the carton. The larger the knock outs 9, the greater the peel and shear strength, and the more difficult it will be to open the carton. Preferably, to reduce the possibility of delamination, the knock outs 9 are no larger in diameter than the punch scores 8.

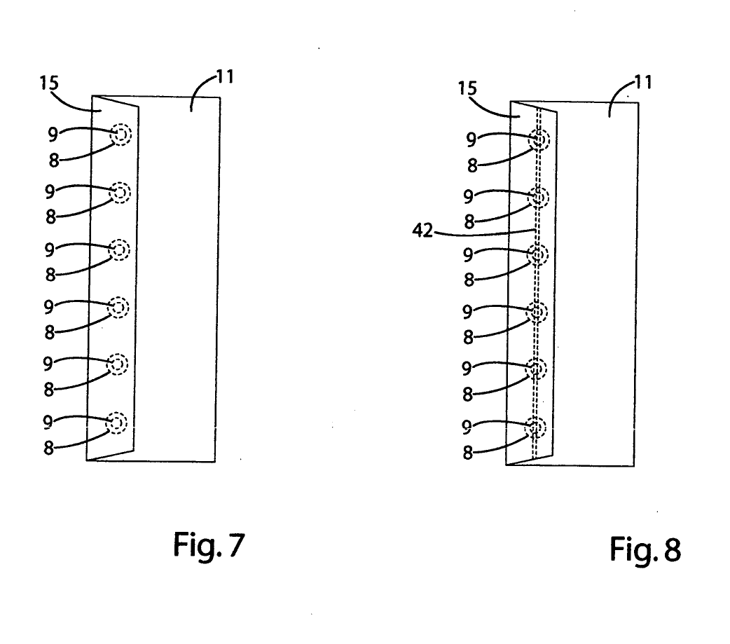

In the preferred embodiment, the number of knock outs 9 is equal to the number of punch scores 8 and the knock outs 9 are circular and slightly smaller in diameter than the punch scores 8. As shown in FIG. 7, the knock outs 9 are preferably positioned so each knock out 9 is coincident with a punch score 8 when the front surface of the adhesive panel 15 is in contact with the back surface of the right panel 11. Although the uncoated stripe 42 was previously described as running through the punch scores 8 on the adhesive panel 15, it could alternatively run in a similar manner through the knock outs 9 on the right panel 11. Regardless of which panel the uncoated stripe 42 is located on, if an uncoated stripe 42 is present it preferably runs through the center of the knock outs 9 and punch scores 8 when the right panel 11 and left panel 13 are in contact, as shown in FIG. 8.

In another alternative embodiment, the knock outs 9 could be located on the adhesive panel 15 rather than the right panel 11, and the punch scores 8 could be located on the right panel 11 rather than the adhesive panel 15 (not shown). In this alternative embodiment, the punch scores 8 and knock outs 9 remain in alignment with one another as in the preferred embodiment.

The blank 10 is folded into a carton 1 using generally conventional techniques and apparatus. The left panel 13 and right panel 11 are folded 90 degrees along fold lines 22 and 21. The back panel 14 is folded 90 degrees in the direction of right panel 11 along fold line 23. Adhesive panel 15 is folded 90 degrees downward along fold line 24. Adhesive panel 15 is placed inside right panel 11 so the punch scores 8 are coincident with the knock outs 9.

The adhesive panel 15 is affixed to the right panel 11 using conventional adhesives. The adhesive used is preferably a water-based adhesive, but other adhesives such as solvent-based adhesives and hot melts may also be used. In the preferred embodiment, the adhesive is a water based cold adhesive. The adhesive is preferably applied in a line extending substantially along the entire length of the adhesive panel 15. There are many methods common in the art for applying such adhesives. For example, the adhesive can be rolled onto the adhesive panel 15 along the punch scores 8, and the adhesive panel 15 and right panel 11 can be pressed together to bind them. This technique is generally performed during the folding process, though it can be done at any time prior to sealing. Another method is to coat the strip of the adhesive panel 15 where the punch scores 8 are located with a heat activated adhesive. The adhesive panel 15 and right panel 11 are then heated and pressed together to bind them. With this method, the adhesive is generally applied to the blank 10 prior to folding, but it can be applied at any time prior to sealing. It is known in the art that the adhesive used can be applied to the adhesive panel 15, right panel 11, or both as long as the adhesive will contact both the punch scores 8 and knock outs 9 when the appropriate panels are in contact. Whatever method is used, the strip of adhesive applied preferably is applied from the top to the bottom of the appropriate panel through the punch scores 8 or knock outs 9. In addition, the strip preferably does not extend beyond the width of the punch scores 8. However, if the strip does extend beyond the width of the punch scores 8., the operability of the easy-open carton will not be affected. If an uncoated stripe 42 is present, the adhesive should run the length of the uncoated stripe 42.

After the right panel 11 and adhesive panel 15 are sealed, dust flaps 28 and 30 are folded at 90 degree angles toward right panel 11 along fold lines 36 and 35 respectively. Dust flaps 27 and 29 are folded at 90 degree angles toward left panel 13 along fold lines 34 and 33 respectively. Bottom closure flap 25 is folded upward at a 90 degree angle along fold line 32 and top closure flap 26 is folded downward at a 90 degree angle along fold line 31. The locking tab 37 of the bottom closure flap 25 is folded at a 90 degree angle toward back panel 14 along fold line 39. The locking tab 37 of the bottom closure flap 25 is inserted into the carton 1 so the front surface of locking tab 37 is in contact with the back surface of back panel 14. In this state, the carton 1 can be readily filled with the desired content.

After the carton 1 is filled, the top of the carton 1 is closed. The locking tab 38 of the top closure flap 26 is likewise folded at a 90 degree angle toward front panel 12 along fold line 40. The locking tab 38 of the top closure flap 26 is folded under front panel 12 so the front surface of locking tab 38 is in contact with the back surface of front panel 12.

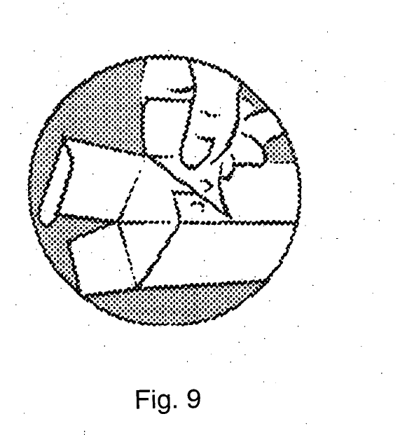

To access the contents of the carton 1, the top closure flap 26 and top dust flaps 29 and 30 are opened. To facilitate showing the user of the product that information on the product is printed on the inside of the container, an icon may be printed on one of the top dust flaps 29 or 30, any other prominent place on the external surface of the carton. An example of such an icon is shown in FIG. 9. After the contents have been removed, the carton 1 is readily unfolded to provide access to information printed on the interior of the carton. The right panel 11 is peeled away from the adhesive panel 15 along the junction between the adhesive panel 15 and the right panel 11. The adhesive panel 15 will readily delaminate at the punch scores 8 providing less resistance to opening than would be required in the absence of the punch scores 8.

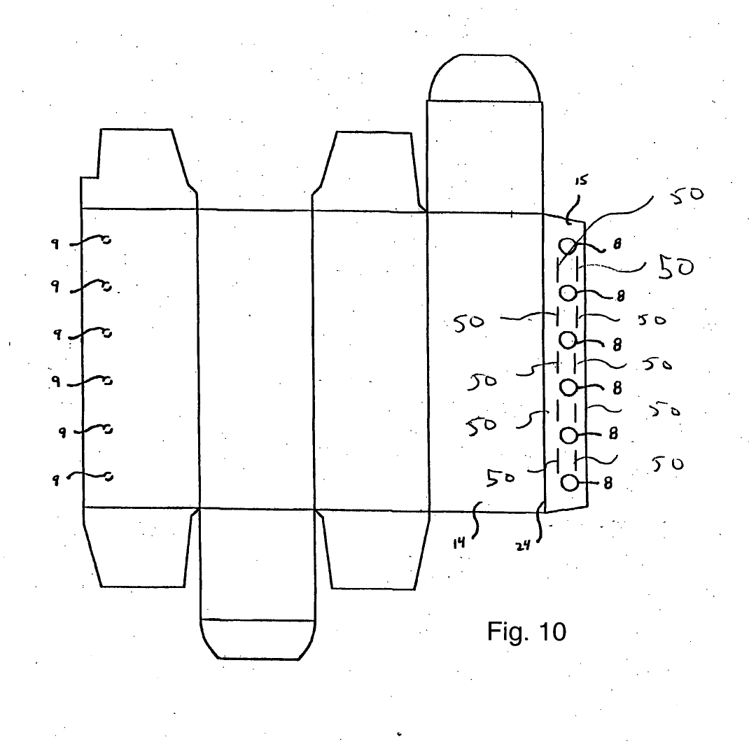

Based on the size of the carton and the weight of the contents contained within the carton, it may be desirable to adjust the peel or shear strength of the carton. In some cases it may be necessary to reduce the peel strength such that the carton can be torn open without causing tears in the fourth panel that adjoins the adhesive strip. In other cases, it may be necessary to increase the shear strength of the carton so that shifting of the contents of the carton during transport does not cause the carton to open prematurely. A number of configurations have been found to be effective, either alone or in combination with several configurations, to adjusting the peel or shear strength. The first of these configurations is the addition of one or more slits 50 between the punch scores as shown in FIG. 10. As shown therein, the slits generally extend between the punch scores 8 near the outer diameter of the punch scores 8. As shown in FIG. 10, it may be desirable to include two parallel slits 50 located on either side of the punch scores 8. Generally, the slits 50 are formed to have the same depth of the punch scores 8, but they need not have the same depth. In addition, the slits 50 may be included between all the punch scores 8 found on the adhesive panel 15 or only between some of the punch scores 8. Generally, the use of slits 50 on the adhesive panel 15 will be included to decrease the peel strength of the carton and to confine the tearing to the “tear strip” created by the parallel set of slits .

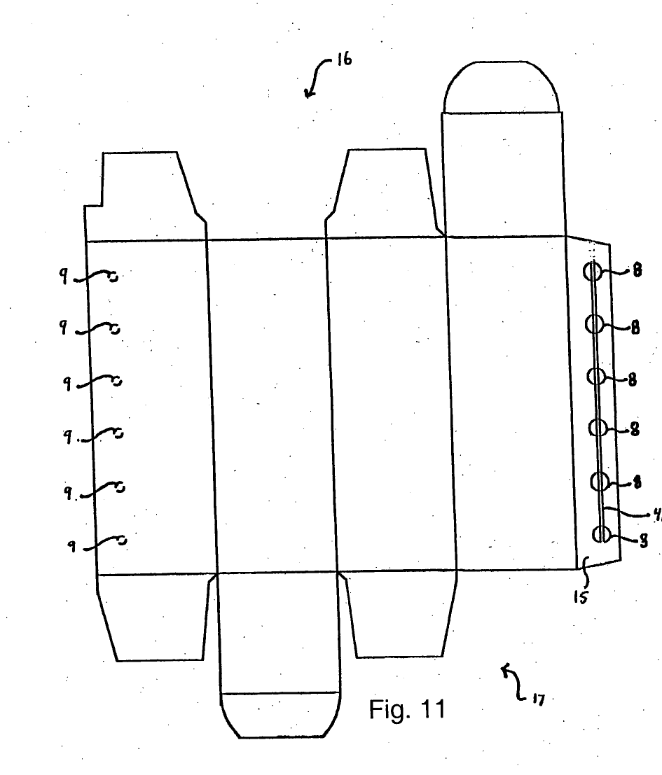

A second configuration is shown in FIG. 11 that is directed to varying the length of the uncoated racing stripe 42 that is typically included over the punch scores 8. In this configuration, the uncoated racing stripe 42 is shortened such that it extends only to the end of the punch scores 8. Alternatively, the uncoated racing stripe 42 can be of any length and width and can be positioned anywhere along the length of the punch scores 8 or the knockouts 9. In general, longer and/or wider uncoated racing stripes 42 will result in a higher peel strength of the carton.

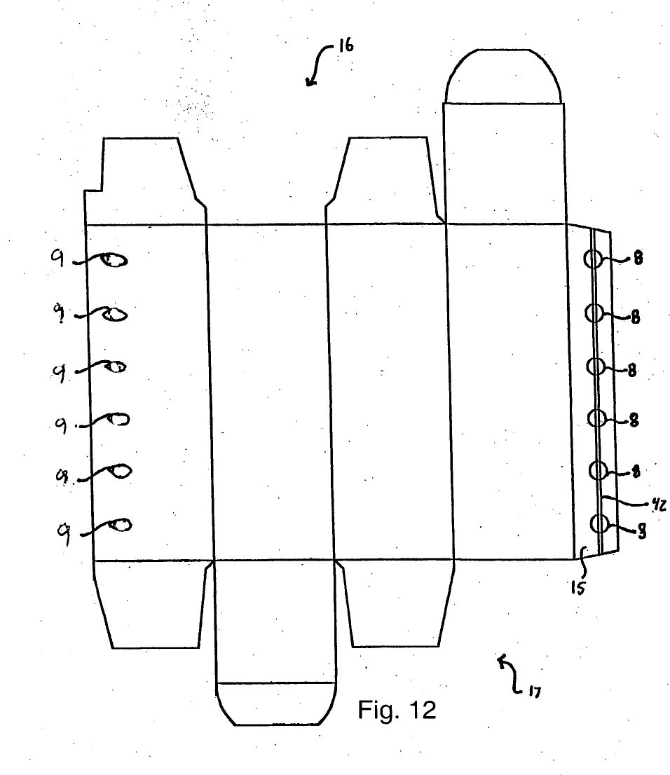

A third configuration is shown in FIG. 12 that is directed to modifying the shape of the knockouts 9 such that they not longer exactly align with the punch scores 8. In the configuration shown in FIG. 12, the knockouts 9 are formed in an oval shape. By increasing the area of the right panel 11 that is uncoated, both the peel and shear strength will be increased.

A fourth configuration that can be used to affect the peel and sheer strength of the carton is to use different types of varnish on the front and back surfaces of the carton. Varnishes are available in a variety of finishes ranging anywhere between dull to matte to shiny. An example of a very shiny varnish is KSS817, INXCURE UV Flexo Coating, manufactured by INX International Inc Co., Edwardsville, Kans. An example of a less shiny varnish is UVC-3500, UV Curable Imprintable Gloss Coating, manufactured by Wikoff Color Corp., Fort Mill, S.C. An example of a matte finish is GREC-252, which is the combination of UV Curable Imprintable Gloss Coating UVC-3550 and OK-412, a dulling/matting agent, manufactured by Wikoff Color Corp., Fort Mill, S.C. Generally, the use of “shinier” varnishes are likely to result in lower peel and shear strengths. Related to this type of variation, a fifth configuration that can be used to affect peel and/or shear strength is to first coat the adhesive panel 15 with an ink that matches the desired color of the carton. The use of ink on the adhesive panel will generally lower the peel strength of the carton since the varnish can not form as strong of a bond with the paperboard blank.

Table 1 shows how combinations of the configurations described above can be used to modify the peel strength and/or shear strength of any carton. The following combinations are well suited for “tall” cartons. As used herein, a tall carton has depth (D) that is greater than either the length (L) and/or width (W) of a carton as shown in FIG. 2. Generally, a “tall” carton may have depth to length to width ratio of about 1.01 to 1 to 1 (1.01:1:1) to about 10 to 1 to 1 (10:1:1).

TABLE 1

| Example | | | | Type of | |
|---|---|---|---|---|---|
| No. | Punch Score | Knockouts | Uncoated Racing Stripe | Varnish | Other Coating |
| 1 | Combination of | Same size, shape and | Present over the punch scores | KSS817 | N/A |
| | round punch scores | location of the punch | and extends over the entire | | |
| | and slit scores | scores | length of the adhesion panel | | |
| 2 | Combination of | Same size, shape and | Present over the punch scores | GREC252 | N/A |
| | round punch scores | location of the punch | and extends over the entire | | |
| | and slit scores | scores | length of the adhesion panel | | |
| 3 | Combination of | Same size, shape and | Present over the punch scores | UVC3550 | N/A |
| | round punch scores | location of the punch | and extends over the entire | | |
| | and slit scores | scores | length of the adhesion panel | | |
| 4 | Combination of | Same size, shape and | Present over the punch scores | KSS817 | N/A |
| | round punch scores | location of the punch | but extends only over the | | |
| | and slit scores | scores | punch scores such that the | | |
| | | | ends on either side of the | | |
| | | | punch scores are lacking the | | |
| | | | uncoated racing stripe. | | |
| 5 | Combination of | Same size, shape and | Present over the punch scores | GREC252 | N/A |
| | round punch scores | location of the punch | but extends only over the | | |
| | and slit scores | scores | punch scores such that the | | |
| | | | ends on either side of the | | |
| | | | punch scores are lacking the | | |
| | | | uncoated racing stripe. | | |
| 6 | Combination of | Same size, shape and | Present over the punch scores | UVC3550 | N/A |
| | round punch scores | location of the punch | but extends only over the | | |
| | and slit scores | scores | punch scores such that the | | |
| | | | ends on either side of the | | |
| | | | punch scores are lacking the | | |
| | | | uncoated racing stripe. | | |
| 7 | Combination of | Same size, shape and | Present over the punch scores | KSS817 | Prior to coating |
| | round punch scores | location of the punch | and extends over the entire | | the adhesions strip |
| | and slit scores | scores | length of the adhesion panel | | with varnish, an |
| | | | | | undercoating of |
| | | | | | ink that matches |
| | | | | | the desired carton |
| | | | | | color is applied to |
| | | | | | the adhesions strip |
| 8 | Combination of | Same size, shape and | Present over the punch scores | GREC252 | Prior to coating |
| | round punch scores | location of the punch | and extends over the entire | | the adhesions strip |
| | and slit scores | scores | length of the adhesion panel | | with varnish, an |
| | | | | | undercoating of |
| | | | | | ink that matches |
| | | | | | the desired carton |
| | | | | | color is applied to |
| | | | | | the adhesions strip |
| 9 | Combination of round | Same size, shape and | Present over the punch | UVC3550 | Prior to coating |
| | punch scores and slit | location of the punch | scores and extends over | | the adhesions strip |
| | scores | scores | the entire length of the | | with varnish, an |
| | | | adhesion panel | | undercoating of |
| | | | | | ink that matches |
| | | | | | the desired carton |
| | | | | | color is applied to |
| | | | | | the adhesions strip |
| 10 | Combination of round | Same size, shape and | Present over the punch | KSS817 | Prior to coating |
| | punch scores and slit | location of the punch | scores but extends only | | the adhesions strip |
| | scores | scores | over the punch scores | | with varnish, an |
| | | | such that the ends on | | undercoating of |
| | | | either side of the punch | | ink that matches |
| | | | scores are lacking the | | the desired carton |
| | | | uncoated racing stripe | | color is applied to |
| | | | | | the adhesions strip |
| 11 | Combination of round | Same size, shape and | Present over the punch | GREC252 | Prior to coating |
| | punch scores and slit | location of the punch | scores but extends only | | the adhesions strip |
| | scores | scores | over the punch scores | | with varnish, an |
| | | | such that the ends on | | undercoating of |
| | | | either side of the punch | | ink that matches |
| | | | scores are lacking the | | the desired carton |
| | | | uncoated racing stripe | | color is applied to |
| | | | | | the adhesions strip |
| 12 | Combination of round | Same size, shape and | Present over the punch | UVC3550 | Prior to coating |
| | punch scores and slit | location of the punch | scores but extends only | | the adhesions strip |
| | scores | scores | over the punch scores | | with varnish, an |
| | | | such that the ends on | | undercoating of |
| | | | either side of the punch | | ink that matches |
| | | | scores are lacking the | | the desired carton |
| | | | uncoated racing stripe | | color is applied to |
| | | | | | the adhesions strip |

Table 2 describes various combinations of the peel and shear strength modifying configurations that are well suited for “short” cartons. As used herein, “short” cartons generally have a depth (D) that is equal to or less than either the length (L) and/or width (W) of the carton. More specifically, short cartons typically have a depth to length to width ratio of about 1 to 1 to 1 (1:1:1) to about 0.1 to 1 to 1 (0.1:1:1)

TABLE 2

| Example | | | Uncoated Racing | | |
|---|---|---|---|---|---|
| No. | Punch Score | Knockouts | Stripe | Type of Varnish | Other Coating |
| 1 | Round punch scores | Same size, shape and | No uncoated racing | The entire | N/A |
| | having a diameter of | location of the punch | stripe | adhesive panel is | |
| | 3/16. | scores | | not coated with | |
| | | | | varnish. | |
| 2 | Round punch scores | Same size, shape and | The width of the | UVC-3550 | N/A |
| | having a diameter of | location of the punch | uncoated racing stripe | | |
| | 3/16. | scores | is about 1/16 inch. | | |
| 3 | Round punch scores | Same size, shape and | The width of the | UVC-3550 | N/A |
| | having a diameter of | location of the punch | uncoated racing stripe | | |
| | 3/16. | scores | is increased to ¼ inch | | |
| 3 | Round punch scores | Rectangular shaped | The width of the | UVC-3550 | N/A |
| | having a diameter of | knock outs (3/16 by | uncoated racing stripe | | |
| | 3/16. | ⅜) having a larger | is increased to ¼ inch | | |
| | | area than the punch | | | |
| | | scores but located to | | | |
| | | generally align with | | | |
| | | round punch scores. | | | |

The above description is that of preferred embodiments of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles a, an, the or said, is not to be construed as limiting the element to the singular.

The embodiments of the invention in which an exclusive property or privilege is claimed are defined as follows:

1. A folding carton comprising:
a first panel having a thickness and a surface, said first panel including a plurality of punch scores in said surface of said first panel, said punch scores extending only partially through said thickness;
a second panel disposed adjacent to said first panel, said second panel including a surface facing said surface of said first panel, said surface of said second panel being at least partially coated and defining a plurality of uncoated knock-outs, said knock outs being aligned with said punch scores; and
an adhesive disposed between said first panel and said second panel adhesively joining said first panel and said second panel, said adhesive disposed in alignment with said punch scores and said knock outs, and wherein said punch scores and knock outs are modified in either size, shape, number or location to achieve a predetermined peel strength and shear strength of the carton.

2. The carton of claim 1 further defining an uncoated stripe running through said knockouts on said second panel.

3. The carton of claim 1 further including a coating on said surface of said first panel.

4. The carton of claim 3 further defining an uncoated stripe running through said punch scores on said first panel.

5. The carton of claim 4 wherein said adhesive is a water-based adhesive.

6. The carton of claim 4 wherein said first panel is an adhesive panel and said second panel is a right panel.

7. The carton of claim 6 further including a front panel hingedly attached to said right panel, a left panel hingedly attached to said front panel and a back panel hingedly attached to said left panel and said adhesive panel.

8. The carton of claim 7 further including a first closure flap hingedly attached to said front panel and a second closure flap hingedly attached to said back panel, each of said closure flaps hingedly attached to a locking tab.

9. The carton of claim 8 further including a plurality of dust flaps hingedly attached to each of said right panel and said left panel.

10. The carton of claim 9 further including an interior surface and an exterior surface and a coating on said interior surface and said exterior surface.

11. The carton of claim 10 wherein said coating is a UV varnish.

12. The carton of claim 4 wherein each of said punch scores penetrates approximately ½ said thickness of said adhesive panel.

13. The carton of claim 12 wherein the coating is a UV varnish.

14. A carton blank comprising:
a first panel having a surface, said surface of said first panel being at least partially coated and defining a plurality of knock outs; and
a second panel having a thickness and a surface, said second panel including a plurality of punch scores in said surface of said second panel, said punch scores extending only partially through said thickness, said punch scores being configured to align with said knockouts when said blank is folded to form a carton.

15. The carton blank of claim 14 further defining an uncoated stripe running through said knock outs on said first panel.

16. The carton blank of claim 14 wherein said surface of said second panel includes a coating.

17. The carton blank of claim 16 further defining an uncoated stripe running through said punch scores on said second panel.

18. The carton blank of claim 14 wherein said punch scores penetrate approximately ½ said thickness of said second panel.

19. The carton blank of claim 18, wherein said first panel is a right panel and said second panel is an adhesive panel.

20. The carton blank of claim 19 further including a front panel hingedly attached to said right panel, a left panel hingedly attached to said front panel and a back panel hingedly attached to said left panel and said adhesive panel.
